(19) United States
(12) Patent Application Publication
(10) Pub. No.: US 2008/0267176 A1
(43) Pub. Date: Oct. 30, 2008

(54) SELECTIVE PRESERVATION OF NETWORK STATE DURING A CHECKPOINT

(76) Inventors: PERINKULAM I. GANESH, Round Rock, TX (US); Vinit Jain, Austin, TX (US); Venkat Venkatsubra, Austin, TX (US)

Correspondence Address: IBM CORP (YA);C/O YEE & ASSOCIATES PC, P.O. BOX 802333, DALLAS, TX, 75380, US

(21) Appl. No.: 11/741,322

(22) Filed: Apr. 27, 2007

(51) Int. Cl. H04L 12/56

(52) U.S. Cl. 370/389

(57) ABSTRACT

A computer implemented method, data processing system, and computer program product for selectively preserving network state during a checkpoint operation. Packets flowing through a network stack are examined to determine whether the packets belong to a WPAR under checkpoint. If one or more packets belong to a WPAR under checkpoint, a filter is used to block the packets from flowing through the network stack. Address information in each blocked packet is checked against an access list of allowed communications to determine if the access list indicates that a packet is an allowed packet. If the access list indicates that one of the packets is an allowed packet, that packet is unblocked and allowed to continue flowing through the network stack during the checkpoint operation. If the access list indicates that another of the packets is not an allowed packet, that packet is discarded during the checkpoint operation.

### BACKGROUND OF THE INVENTION

1. Field of the Invention

The present invention relates generally to an improved data processing system, and in particular to a computer implemented method, data processing system, and computer program product for selectively preserving network state during a checkpoint operation.

2. Description of the Related Art

Most data processing systems use data integrity operations for ensuring that the state of data in memory may be recreated in the event of a failure. A checkpoint operation is a data integrity operation in which the application state and memory contents for an application are written to stable storage at particular time points, i.e., checkpoints, in order to provide a basis upon which to recreate the state of an application in the event of a failure. For example, during a typical checkpoint operation, an application's state and data are saved onto a network disk at various pre-defined points in time. When a failure occurs, a restart operation may be performed to roll back the state of the application to the last checkpoint, such that the application data may be restored from the values stored on the network disk.

AIX® Workload Partition (WPAR) is a product available from International Business Machines Corporation. A WPAR is a portion or representation of a system within an operating system. A WPAR is comprised of a group of processes, and the group of processes is not allowed to interact with other processes in other workload partitions. The only way for processes to interact with processes in other WPARs is via the network.

During a checkpoint, it is imperative that the state of the things being saved is preserved. The network state can be modified by an application reading or writing data, data being received or sent over the network, or the timer state being modified by the timer processing. During a checkpoint, the applications are frozen so that they cannot perform any read or write operations. Thus, current checkpointing techniques do not support applications communicating over the network or in other cases block all communication over the network during the checkpoint, thereby preventing checkpoint data from being received by or sent to the network-based file system.

### SUMMARY OF THE INVENTION

The illustrative embodiments provide a computer implemented method, data processing system, and computer program product for selectively preserving network state during a checkpoint operation. Packets flowing through a network stack are examined to determine whether the packets belong to a WPAR under checkpoint. If one or more packets belong to a WPAR under checkpoint, a filter is used to block the packets from flowing through the network stack. Address information in each blocked packet is checked against an access list of allowed communications to determine if the access list indicates that a packet is an allowed packet. If the access list indicates that one of the packets is an allowed packet, that packet is unblocked and allowed to continue flowing through the network stack during the checkpoint operation. If the access list indicates that another of the packets is not an allowed packet, that packet is discarded during the checkpoint operation.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system in which the illustrative embodiments may be implemented;

FIG. 2 is a block diagram of a data processing system in which the illustrative embodiments may be implemented;

FIG. 3 is a block diagram of exemplary components with which the illustrative embodiments may be implemented;

FIG. 4 is a flowchart illustrating a process for initiating a checkpoint operation in accordance with the illustrative embodiments;

FIG. 5 is a flowchart illustrating a process for terminating a checkpoint or restart operation in accordance with the illustrative embodiments;

FIG. 6 is a flowchart illustrating a process for updating an access list using an Application Programming Interface (API) call in accordance with the illustrative embodiments;

FIG. 7 is a flowchart illustrating a process for selectively preserving network state during a checkpoint operation in accordance with the illustrative embodiments; and

FIG. 8 is a flowchart illustrating a process for preserving the state of the Transmission Control Protocol (TCP) timers during a checkpoint operation in accordance with the illustrative embodiments.

### DETAILED DESCRIPTION OF THE PREFERRED EMBODIMENT

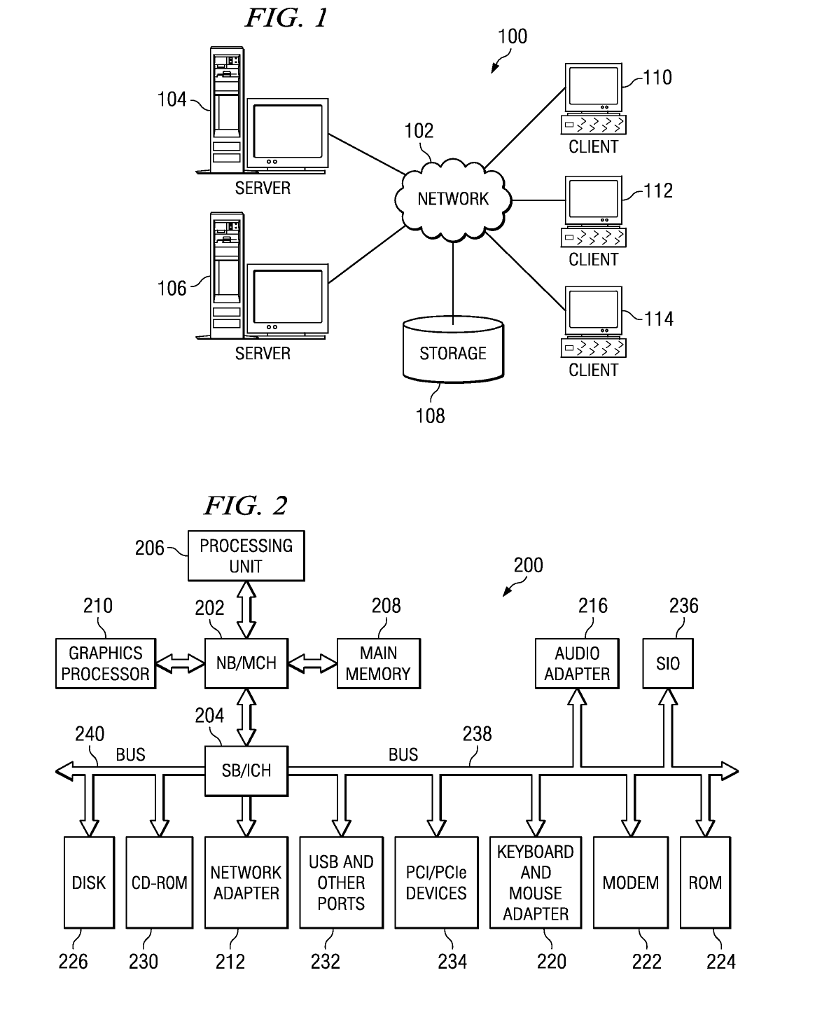

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including a north bridge and memory controller hub (NB/MCH) 202 and a south bridge and input/output (I/O) controller hub (SB/ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the NB/MCH through an accelerated graphics port (AGP) for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238, and hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The illustrative embodiments provide a computer implemented method, data processing system, and computer program product for selectively preserving network state during a checkpoint operation. When workload partitions (WPARs) are running in a system, the illustrative embodiments allow for checkpointing a WPAR by ‘freezing’ the network state, and saving the state onto another disk (e.g., remote disk, local disk, etc.). The network state includes the activities of all of the processes of the WPAR on the network. Later, the frozen network state may be restored or restarted using the data on the network disk. The restart recreates the processes running on the WPAR in the same condition and connectivity as they were prior to the checkpoint.

When checkpointing a WPAR, the network state is frozen in order to preserve the state of all of the processes in the WPAR. However, there may also be processes running in the WPAR which perform the checkpointing process. For instance, there may be processes running on the WPAR that perform the freezing and saving of the state to a remote disk. Thus, there is a need to allow some communication for select applications of the WPAR which perform the actual checkpointing operation. The illustrative embodiments provide a mechanism which allows for preserving the network state in such a manner that allows select processes of the WPAR being checkpointed to continue to keep communicating on the network, while blocking the communications of other processes of the WPAR.

To preserve the network state during a checkpoint operation, the illustrative embodiments first block all incoming and outgoing traffic for the WPAR under checkpoint. Network packets may be blocked by adding a lightweight Internet Protocol (IP) filter which examines all of the packets that are flowing through the network stack. If any of the packets is marked as belonging to the particular WPAR, the packet is discarded (thrown away).

The illustrative embodiments also visit all connections (sockets) that are open for the particular WPAR and mark all of those connections as frozen. Marking the connections in this manner freezes the Transmission Control Protocol (TCP) retransmission timers in the networking kernel. TCP uses retransmission timers to ensure that a sent packet has been received in the absence of any feedback from the remote receiver. For instance, if no acknowledge transmission is received from the remote receiver, the packet may be resent after the retransmission timer times-out. Freezing the retransmission timers ensures that the state of the connection cannot be affected at this point.

The illustrative embodiments also provide an Application Programming Interface (API) to special applications running in the WPAR and who are performing the checkpoint operation and saving the network state. These special processes may use the API to make a call to the networking layer passing in a file descriptor to indicate that particular network connections should not be frozen. The file descriptor points to the network connection of the process. The filter takes the network source and destination IP address and the source and destination port from this connection and adds this information to an “allow” list. The filter also un-marks this network connection so that it no longer is frozen. The effect of adding the information to the “allow” list and unmarking the network connection so that it no longer is frozen is that an application is now able to use this network connection for communication.

For example, the IP filter may examine a packet to determine whether the packet belongs to the WPAR under checkpoint. Incoming packets are marked with the WPAR identification tag as they enter the system. Outgoing packets are marked with the WPAR identification tag based on the process that is sending the packet. If the filter sees that the WPAR identification tag indicates that the packet belongs to the WPAR under checkpoint, the filter will discard the packet. However, the filter may also check an access list to determine whether this packet is an allowable packet by checking the addressing information in the packet. For instance, the filter may check the source IP address, source port, destination IP address, and destination port information in the packet. If the network addressing information of the packet is in the access list in the form of an “allow” filter, the packets are not discarded and are allowed to pass through the filter while other network connections of the WPAR remain frozen.

At a later time, when the special application has finished its activities on the network, the special application makes a call to the network layer to indicate that the application no longer needs to communicate over the network during the checkpoint operation. The “allow” filter for the application comprising the addressing information is then removed from the access list. The special application is thereby no longer able to communicate on the network.

When the checkpoint operation is complete, two things may occur. If the WPAR is migrated to another system, the original WPAR may be destroyed. In this scenario, all filters are removed, since there are no longer any processes in the WPAR which need filtering. In another scenario, the WPAR is migrated to another machine, and the restore is performed on that machine. During the restoration, the same mechanism of selective preservation is used so that the processes restoring the state may read from the network disk while all other restored connections are frozen. In the end, the migrated WPAR is allowed to continue as usual, and the filters are removed. An Address Resolution Protocol (ARP) packet may be broadcast to inform other WPARs as to the current address of the WPAR (since it was migrated). Thus, when the processes and connections are recreated on the new machine, the ARP packet is used to notify others as to the location of the WPAR in the system.

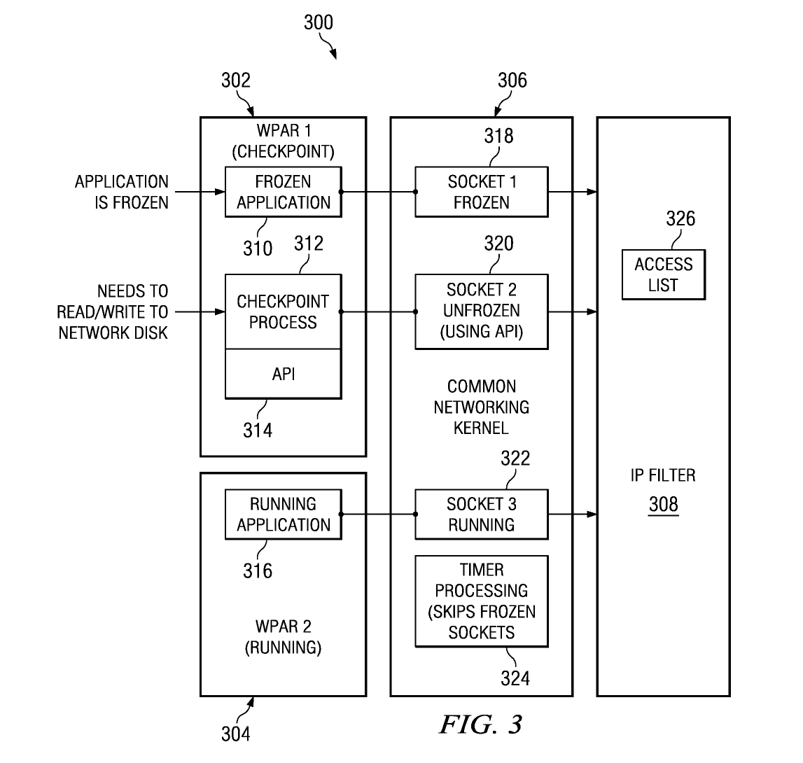

FIG. 3 is a block diagram of exemplary components with which the illustrative embodiments may be implemented. Data processing system 300 may be implemented in, for example, data processing system 100 in FIG. 1. Data processing system 300 includes workload partitions WPAR 1 302 and WPAR 2 304, common networking kernel 306, and IP filter 308.

In this illustrative example, WPAR 1 302 is the workload partition in data processing system 300 on which a checkpoint operation is performed. WPAR 1 302 comprises frozen application 310, checkpoint process 312, and application programming interface (API) 314. In order to preserve the network state, the network state for WPAR 1 302 must first be frozen. The network state may be frozen by blocking all incoming and outgoing communication for WPAR 1 302 during the checkpoint operation. Blocking all communication to WPAR 1 302 halts the network activity running on WPAR 1 302, as shown by frozen application 310. However, WPAR 1 302 also includes processes which need to run to perform the checkpoint operation. These processes are represented by checkpoint process 312. The illustrative embodiments provide for selectively preserving the network state of WPAR 1 302 by allowing certain processes to keep communicating during the checkpoint process. For instance, checkpoint process 312 may read and write to a network disk in order to save the checkpoint data, while application 310 continues to be frozen.

WPAR 2 304 is a workload partition in data processing system 300 which comprises running processes within running application 316. Processes running on WPAR 2 304 are not allowed to interact with other processes on other workload partitions, such as WPAR 1 302.

Common networking kernel 306 comprises various socket connections, including socket 1 connection 318, socket 2 connection 320, and socket 3 connection 322. Frozen application 310 in WPAR 1 302 uses socket 1 connection 318, checkpoint process 312 in WPAR 1 302 uses socket 2 connection 320, and running application 316 in WPAR 2 304 uses socket 3 connection 322. Common networking kernel 306 also comprises timer processing 324. Timer processing 324 is a process used to freeze TCP retransmission timers. The illustrative embodiments preserve the state of the retransmission timers by marking the connections to frozen applications as frozen as well. If a socket is marked as frozen (such as socket 1 connection 318), timer processing 324 does not process the connection. Preserving the retransmission timers ensures that there will be no regression of the TCP windows due to advancing timers, and the connection performance will not deteriorate after a checkpoint or restart.

IP filter 308 is a lightweight filter in the Internet Protocol (IP) path which is used to control packet movement through the network by allowing or denying packets from crossing specified interfaces. IP filter 308 may be activated when the checkpoint operation is initiated. IP filter 308 filters incoming or outgoing data packets based on the WPAR identification information and the addressing information in the packet. The addressing information in the packet may include source IP addresses, source port, destination IP addresses, and destination port, among others. This WPAR identification information may be used by IP filter 308 to determine to which WPAR the packet belongs. Thus, an inbound packet marked as belonging to WPAR 1 302 may be discarded during the checkpoint operation. However, IP filter 308 also checks the addressing information in the packet to identify certain packets belonging to WPAR which may be allowed through IP filter 308. For example, packets belonging to checkpoint process 312 in WPAR 1 302 may be allowed to pass through IP filter 308, while an inbound packet for frozen application 310 will be discarded. IP filter 308 uses access list 326 to determine which packets to allow or discard. Access list 326 may include permit and discard conditions that apply to IP addresses. For example, after receiving an inbound packet for WPAR 1 302, the source IP address of the packet may be checked against access list 326. If access list 326 permits the source IP address, the source port of the packet is checked against access list 326. This process continues until the combination of the source IP address, source port, destination IP address, and destination port found in the packet are determined to be allowed by access list 326. At this point, the packet is allowed to pass through IP filter 308. If access list 326 does not have the combination, the packet is discarded.

Although the illustrative embodiments describe filtration based on the combination of the source IP address, source port, destination IP address, and destination port in the packet, it should be noted that any suitable type of filtration may be used. For instance, access list 326 may also allow blanket filtration to permit all communications to a particular machine on a particular port. This filter is lightweight since for most of the traffic from other WPARs, only one value (WPAR identification tag) will be sufficient to allow the packets. For the WPAR being checkpointed, the lightweight filter is an efficient mechanism since during a checkpoint only a few number of connections will be used, and therefore the access list will be small.

API 314 is provided to special applications (e.g., checkpoint process 312) in checkpointed WPAR 1 302. Since these special applications have a need to continue to communicate during the checkpointing operation, API 314 allows these applications to pass in the file descriptor of its connection to IP filter 308. By providing the file descriptor to IP filter 308, IP filter 308 adds the connection information to the filter's list of allowed communications. Thus, this connection will be unblocked, and any packet on the connection will be allowed to pass through. Passing in the file descriptor also unmarks the connection so that timer processing 324 may occur on the non-frozen socket. Once the special application completes its processes, checkpoint process 312 may again use API 314 to pass in the file descriptor to IP filter 308. By passing the file descriptor this time, IP filter 308 may reblock the connection.

After a successful checkpoint, WPAR 1 302 may resume or restart its operations. The network state is unfrozen by removing all IP filters 308 for WPAR 1 302, thereby allowing all packets to flow through. All connections (e.g., socket 1 318, socket 2 320) belonging to WPAR 1 302 are also unmarked so that timer processing 324 may resume. An ARP packet may also be generated so that the switch infrastructure may learn the new location of the restarted WPAR.

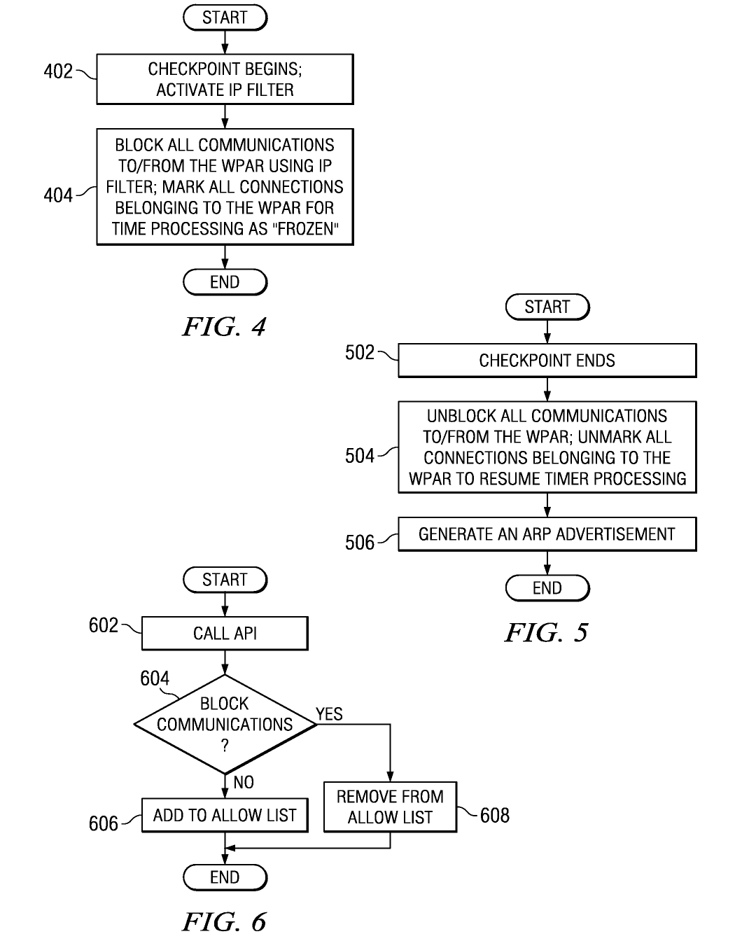

FIG. 4 is a flowchart illustrating a process for initiating a checkpoint operation in accordance with the illustrative embodiments. The process described in FIG. 4 may be implemented in data processing system 300 in FIG. 3. The process begins with initiating a checkpoint operation on a WPAR (step 402). When the checkpoint is initiated, the IP filter, such as IP filter 308 in FIG. 3, may be activated at that time.

During the checkpoint operation, the network state of the WPAR is frozen by blocking all communications to and from the WPAR using the IP filter, and by marking all connections which belong to the WPAR as frozen (step 404).

FIG. 5 is a flowchart illustrating a process for terminating a checkpoint operation in accordance with the illustrative embodiments. The process described in FIG. 5 may be implemented in data processing system 300 in FIG. 3. The process begins when the checkpoint operation on the WPAR is terminated (step 502). After the checkpoint operation is completed, the network state of the WPAR is unfrozen by unblocking all communications to and from the WPAR, and by unmarking all connections which belong to the WPAR as ‘frozen’ to resume timer processing (step 504). For instance, the network state may be unfrozen by removing all IP filters placed on the WPAR. An ARP advertisement is then generated to inform other WPARs as to the current address of the restarted WPAR in the system (step 506). Generating the ARP advertisement may also be useful after a checkpoint and continue since it may be possible that the switch infrastructure has timed out the ARP entry for the WPAR IP address due to non-activity in that segment.

FIG. 6 is a flowchart illustrating a process for updating an access list using an API call in accordance with the illustrative embodiments. The process described in FIG. 6 may be implemented in data processing system 300 in FIG. 3.

The process begins with an application in the WPAR under checkpoint, such as checkpoint process 312 in FIG. 3, making a call to the special API provided to the application (step 602). The call may comprise a file descriptor which identifies a connection used by the application. A determination is then made as to whether the call comprises a request to block all communications associated with the file descriptor (step 604). If the call comprises a request to block all communications associated with the file descriptor (‘yes’ output of step 604), the IP filter removes the file descriptor from the allowed list (step 606). Consequently, all communications to or from the application will now be blocked.

Turning back to step 604, if the call comprises a request to unblock all communications associated with the file descriptor (‘no’ output of step 604), the IP filter adds the file descriptor to the allowed list (step 608). In this manner, the access list in the IP filter now contains information which will allow communications from the application on that connection to selectively pass through the filter.

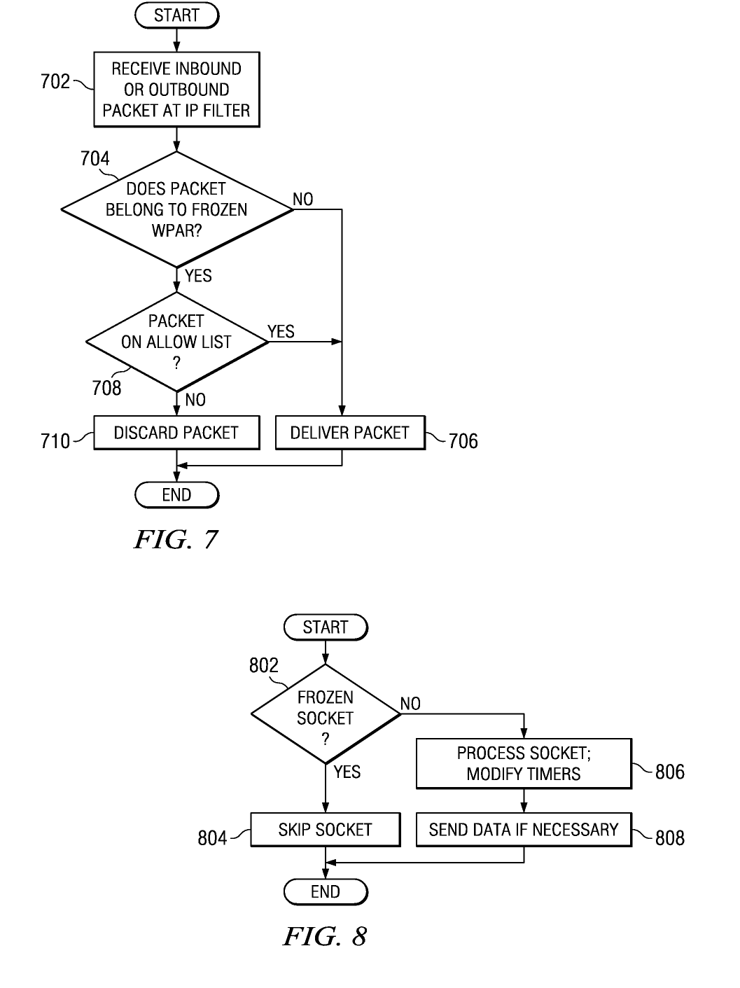

FIG. 7 is a flowchart illustrating a process for selectively preserving network state during a checkpoint operation. The process described in FIG. 7 may be implemented in data processing system 300 in FIG. 3. The process begins when an inbound or outbound packet is received at the IP filter (step 702). A determination is then made as to whether the packet belongs to a WPAR under checkpoint (step 704), such as frozen WPAR 1 302 in FIG. 3. If the IP filter determines that the packet does not belong to a frozen WPAR (‘no’ output of step 704), the IP filter allows the packet to pass through, and the packet is delivered to its intended destination (step 706).

Turning back to step 704, if the IP filter determines that the packet does belong to a frozen WPAR (‘yes’ output of step 704), the IP filter makes a determination whether the access list indicates that the packet is ‘allowed’ (step 708). If the IP filter determines that the packet is on the allowed list, (‘yes’ output of step 708), the IP filter allows the packet to pass through, and the packet is delivered to its intended destination (step 706). If the IP filter determines that the packet is not on the allowed list, (‘no’ output of step 708), the IP filter does not allow the packet to pass through and discards the packet (step 710).

FIG. 8 is a flowchart illustrating a process for preserving the state of the TCP timers during a checkpoint operation in accordance with the illustrative embodiments. The process described in FIG. 8 may be implemented in data processing system 300 in FIG. 3. The process described in FIG. 8 may be performed periodically (e.g., several times a second) and is shared by all WPARs in the system.

The process begins with the timer processing function in the networking kernel making a determination whether a particular socket connection has been frozen by a checkpoint operation on a WPAR (step 802). If the socket connection has been frozen (‘yes’ output of step 802), the timer processing function skips the retransmission timer processing of that socket (step 804).

Turning back to step 802, if the socket connection has not been frozen (‘no’ output of step 802), the timer processing function processes the socket and modifies the retransmission timers (step 806). For instance, the various TCP timer values may be counted for each loop. When the timer value reaches the target, an operation is initiated (e.g., retransmit packet, timeout and close the connection, etc.) The timer processing function may retransmit the packet if necessary (step 808) (i.e., if the timer value times-out prior to receiving acknowledgement from the device receiving the packet).

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for selectively preserving network state of a workload partition during a checkpoint operation, the computer implemented method comprising:
examining packets flowing through a network stack to determine whether the packets belong to a workload partition under checkpoint;
responsive to determining that one or more packets belong to a workload partition under checkpoint, using a filter to block the one or more packets belonging to the workload partition from flowing through the network stack;
checking address information in each blocked packet against an access list of allowed communications to determine if the access list indicates that a packet in the one or more blocked packets is an allowed packet;
responsive to determining that the access list indicates that a first packet in the one or more blocked packets is an allowed packet, unblocking the first packet and allowing the first packet to continue flowing through the network stack during the checkpointing operation; and
responsive to determining that the access list indicates that a second packet in the one or more blocked packets is not an allowed packet, discarding the second packet.

2. The computer implemented method of claim 1, further comprising:
responsive to completion of the checkpoint operation, removing the filter from the workload partition under checkpoint; and
restarting processes running on the workload partition in a same condition and network connectivity as prior to the checkpoint operation.

3. The computer implemented method of claim 1, wherein examining packets flowing through a network stack and blocking the one or more packets belonging to the workload partition is performed using a lightweight Internet Protocol filter.

4. The computer implemented method of claim 1, wherein the first packet belongs to a first application in the workload partition which performs the checkpoint operation, and wherein the second packet belongs to a second application in the workload partition which does not perform the checkpoint operation.

5. The computer implemented method of claim 1, wherein blocking the one or more packets belonging to the workload partition further comprises:
marking all open network connections for the workload partition as frozen.

6. The computer implemented method of claim 5, wherein marking the open network connections prevents Transmission Control Protocol retransmission timers from processing packets on the open network connections.

7. The computer implemented method of claim 1, wherein the first application continues to communicate during the checkpointing operation using an application programming interface to pass a file descriptor of a network connection to the filter, and wherein the filter adds the network connection to the access list of allowed communications.

8. The computer implemented method of claim 7, wherein adding the network connection to the access list of allowed communications allows Transmission Control Protocol retransmission timers to process packets on the network connection.

9. The computer implemented method of claim 1, wherein the address information in the packet includes a source Internet Protocol address, source port, destination Internet Protocol address, and destination port information.

10. The computer implemented method of claim 1, wherein the Internet Protocol filter is activated when the checkpoint operation is initiated.

11. The computer implemented method of claim 1, wherein the network state includes activities of all processes of the workload partition.

12. A data processing system for selectively preserving network state of a workload partition during a checkpoint operation, the data processing system comprising:
a bus;
a storage device connected to the bus, wherein the storage device contains computer usable code;
at least one managed device connected to the bus;
a communications unit connected to the bus; and
a processing unit connected to the bus, wherein the processing unit executes the computer usable code to examine packets flowing through a network stack to determine whether the packets belong to a workload partition under checkpoint; use, in response to determining that one or more packets belong to a workload partition under checkpoint, a filter to block the one or more packets belonging to the workload partition from flowing through the network stack; check address information in each blocked packet against an access list of allowed communications to determine if the access list indicates that a packet in the one or more blocked packets is an allowed packet; unblock, in response to determining that the access list indicates that a first packet in the one or more blocked packets is an allowed packet, the first packet and allowing the first packet to continue flowing through the network stack during the checkpointing operation; and discarding, in response to determining that the access list indicates that a second packet in the one or more blocked packets is not an allowed packet, the second packet.

13. A computer program product for selectively preserving network state of a workload partition during a checkpoint operation, the computer program product comprising:
a computer usable medium having computer usable program code tangibly embodied thereon, the computer usable program code comprising:
computer usable program code for examining packets flowing through a network stack to determine whether the packets belong to a workload partition under checkpoint;
computer usable program code for using, in response to determining that one or more packets belong to a workload partition under checkpoint, a filter to block the one or more packets belonging to the workload partition from flowing through the network stack;
computer usable program code for checking address information in each blocked packet against an access list of allowed communications to determine if the access list indicates that a packet in the one or more blocked packets is an allowed packet;
computer usable program code for unblocking, in response to determining that the access list indicates that a first packet in the one or more blocked packets is an allowed packet, the first packet and allowing the first packet to continue flowing through the network stack during the checkpointing operation; and
computer usable program code for discarding, in response to determining that the access list indicates that a second packet in the one or more blocked packets is not an allowed packet, the second packet.

14. The computer program product of claim 13, further comprising:
computer usable program code for removing the filter from the workload partition under checkpoint in response to completion of the checkpoint operation; and
computer usable program code for restarting processes running on the workload partition in a same condition and network connectivity as prior to the checkpoint operation.

15. The computer program product of claim 13, wherein the computer usable program code for examining packets flowing through a network stack and blocking the one or more packets belonging to the workload partition is performed using a lightweight Internet Protocol filter.

16. The computer program product of claim 13, wherein the first packet belongs to a first application in the workload partition which performs the checkpoint operation, and wherein the second packet belongs to a second application in the workload partition which does not perform the checkpoint operation.

17. The computer program product of claim 13, wherein the computer usable program code for blocking the one or more packets belonging to the workload partition further comprises:
computer usable program code for marking all open network connections for the workload partition as frozen.

18. The computer program product of claim 17, wherein the computer usable program code for marking the open network connections prevents Transmission Control Protocol retransmission timers from processing packets on the open network connections.

19. The computer program product of claim 13, wherein the first application continues to communicate during the checkpointing operation using an application programming interface to pass a file descriptor of a network connection to the filter, wherein the filter adds the network connection to the access list of allowed communications, and wherein adding the network connection to the access list of allowed communications allows Transmission Control Protocol retransmission timers to process packets on the network connection.

20. The computer program product of claim 13, wherein the address information in the packet includes a source Internet Protocol address, source port, destination Internet Protocol address, and destination port information.
